(19) United States
(12) Patent Application Publication
(10) Pub. No.: US 2022/0279003 A1
(43) Pub. Date: Sep. 1, 2022

(54) ANOMALY DETECTION APPARATUS, ANOMALY DETECTION METHOD, AND COMPUTER-READABLE RECORDING MEDIUM

(71) Applicant: NEC Corporation, Minato-ku, Tokyo (JP)

(72) Inventors: Satoru YAMANO, Tokyo (JP); Takashi KONASHI, Tokyo (JP); Shohei MITANI, Tokyo (JP)

(73) Assignee: NEC Corporation, Minato-ku, Tokyo (JP)

(21) Appl. No.: 17/631,748

(22) PCT Filed: Aug. 9, 2019
(86) PCT No.: PCT/JP2019/031765

§ 371 Date: Jan. 31, 2022

(51) Int. Cl. H04L 9/40

(52) U.S. Cl. CPC H04L 63/1425

(57) ABSTRACT

An anomaly detection apparatus 1 includes a period specification unit 2 that, at the time of learning, classifies learning packets by type, and, with use of a packet interval calculated for every packet type and a frequency indicating an incidence rate of the packet interval, specifies a period of the packet type, and a feature extraction unit 3 that extracts, based on the period, a sequence feature amount having sequence information indicating the order of the packet types and information indicating the time distribution between packets in the sequence information.

### TECHNICAL FIELD

The invention relates to an anomaly detection apparatus and an anomaly detection method for detecting anomalies in a control system, and furthermore relates to a computer-readable recording medium that includes a program recorded thereon for realizing the apparatus and method.

### BACKGROUND ART

In recent years, incident reports relating to control systems have been increasing year by year, giving rise to calls for advanced security measures with respect to control systems.

As a security measure for a control system, Patent Document 1, for example, discloses a monitoring control device that quickly detects sequence anomalies caused by attacks on the control system, using the allowable time of control instruction intervals (e.g., command intervals). This monitoring control device, first, causes a learning unit provided in the monitoring control device to pre-learn a control instruction pattern consisting of control instructions that are issued sequentially to a control target from a logical control device that controls the control target. Next, the monitoring control device compares control instructions issued to the control target by the logical control device with pre-learned control instructions stored in a database, and detects anomalies in the logical control device.

### LIST OF RELATED ART DOCUMENTS

### Patent Document

Patent Document 1: Japanese Patent Laid-Open Publication No. 2018-022296

### SUMMARY

### Technical Problems

However, while the monitoring control device disclosed in Patent Document 1 learns control instruction patterns in advance as mentioned above, only the respective orders of the control instructions and the respective allowable times of the intervals are stored in the database in advance. Also, an allowable threshold value (maximum value) is simply used for the allowable time of the control instruction interval. Thus, it is difficult to cope with advanced attacks on a control system. That is, the monitoring control device disclosed in Patent Document 1 is able to detect anomalies in a control system that is constituted by a single sequence, but has difficultly detecting anomalies in a control system that is constituted by a plurality of sequences.

Also, the monitoring control device disclosed in Patent Document 1 erroneously detects anomalies in the case where packets are delayed due to concentration of traffic or the like, and has difficulty detecting anomalies in the case where the packet interval is changed due to a malware infection of the management control server or unauthorized operation by a malicious operator.

An example object of the invention is to provide an anomaly detection apparatus, an anomaly detection method and a computer-readable recording medium that improve the accuracy of anomaly detection in a control system.

### Solution to the Problems

In order to achieve the above example object, an anomaly detection apparatus according to an example aspect includes:

a period specification unit configured to, at a time of learning, classify learning packets by type, and, with use of a packet interval calculated for every packet type and a frequency indicating an incidence rate of the packet interval, specify a period of the packet type; and

a feature extraction unit configured to extract, based on the period, a sequence feature amount having sequence information indicating an order of the packet types and information indicating a time distribution between packets in the sequence information.

Also, in order to achieve the above example object, an anomaly detection method according to an example aspect includes:

(a) a step of, at a time of learning, classifying learning packets by type, and, with use of a packet interval calculated for every packet type and a frequency indicating an incidence rate of the packet interval, specifying a period of the packet type; and

(b) a step of extracting, based on the period, a sequence feature amount having sequence information indicating an order of the packet types and information indicating a time distribution between packets in the sequence information.

Furthermore, in order to achieve the above example object, a computer-readable recording medium according to an example aspect includes a program recorded thereon, the program including instructions that cause a computer to carry out:

(a) a step of, at a time of learning, classifying learning packets by type, and, with use of a packet interval calculated for every packet type and a frequency indicating an incidence rate of the packet interval, specifying a period of the packet type; and

(b) a step of extracting, based on the period, a sequence feature amount having sequence information indicating an order of the packet types and information indicating a time distribution between packets in the sequence information.

### Advantageous Effects of the Invention

According to the invention as describe above, the accuracy of anomaly detection in a control system can be improved.

### BRIEF DESCRIPTION OF THE DRAWINGS

FIG. 1 is a diagram for describing an example of an anomaly detection apparatus.

FIG. 2 is a diagram for describing an example of a system having the anomaly detection apparatus.

FIG. 3 is a diagram for describing classification of packets.

FIG. 4 is a diagram for describing the relationship between packet interval and frequency of packet A.

FIG. 5 is a diagram for describing an example of the data structure of information that associates classified packets, packet intervals and frequencies.

FIG. 6 is a diagram for describing grouping of packets.

FIG. 7 is a diagram for describing sequence information.

FIG. 8 is a diagram for describing an example of the data structure of sequence feature amounts.

FIG. 9 is a diagram for describing an example of operations of the anomaly detection apparatus in a learning phase.

FIG. 10 is a diagram for describing an example of operations of the anomaly detection apparatus in an operation phase.

FIG. 11 is a diagram showing an example of a computer that realizes the anomaly detection apparatus.

### EXAMPLE EMBODIMENTS

### Example Embodiment

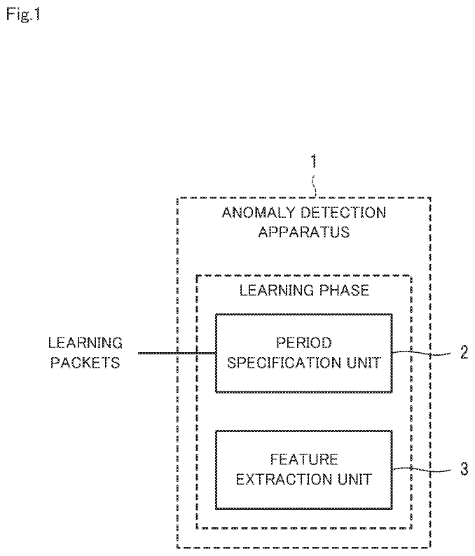

Hereinafter, an example embodiment of the invention will be described, with reference to FIGS. 1 to 11.

[Apparatus Configuration]

Initially, the configuration of an anomaly detection apparatus 1 in the example embodiment will be described using FIG. 1. FIG. 1 is a diagram for describing an example of the anomaly detection apparatus.

The anomaly detection apparatus 1 shown in FIG. 1 is an apparatus that improves the accuracy of anomaly detection in a control system. Also, as shown in FIG. 1, the anomaly detection apparatus 1 has a period specification unit 2 and a feature extraction unit 3.

Of these, the period specification unit 2, at the time of learning, classifies learning packets by type, and specifies the periods of the packet types, using packet intervals calculated for every packet type and frequencies indicating the incidence rates of the packet intervals. The feature extraction unit 3 extracts sequence feature amounts having sequence information indicating the order of packet types and information indicating the time distribution between packets in the sequence, based on the periods.

In this way, with the example embodiment, the accuracy for detecting anomalies that occur in the control system can be improved in the operation phase, by using sequence feature amounts extracted in the learning phase. Specifically, in the operation phase, the accuracy for detecting anomalies that occur in the control system can be improved, by detecting anomalies by reference to sequence feature amounts extracted at the time of learning using packets received from the control system.

Also, even with a control system that is constituted by a plurality of different sequences, respective sequence feature amounts can be extracted, thus enabling anomalies to be accurately detected.

[System Configuration]

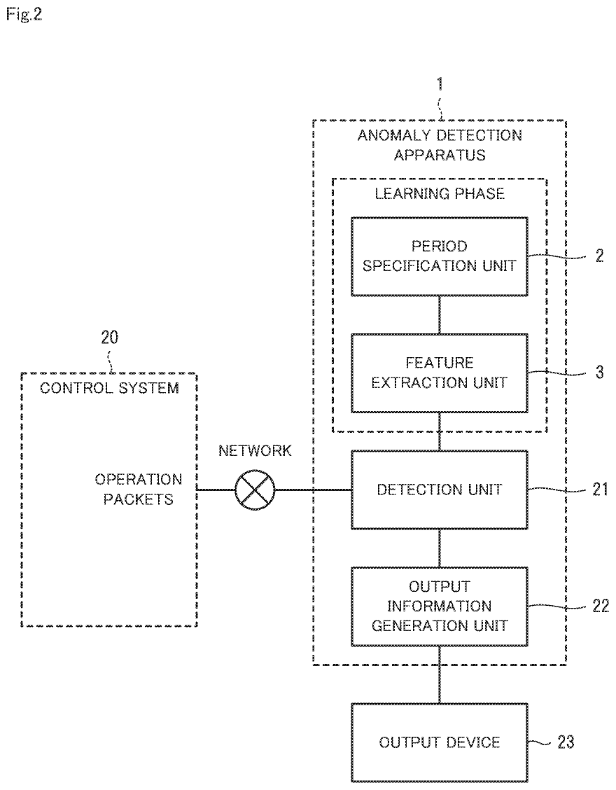

Next, the configuration of the anomaly detection apparatus 1 in the example embodiment will be described more specifically using FIG. 2. FIG. 2 is a diagram for describing an example of the control system having the anomaly detection apparatus. The anomaly detection apparatus 1 shown in FIG. 2 is connected to a control system 20 via a network. The anomaly detection apparatus 1 may, however, be connected to the control system 20 other than via a network.

The control system 20 is, for example, a system having an information processing apparatus, controller, devices, network and the like that is constructed in a plant, factory, vehicle, household appliance or the like. Of these, the information processing apparatus is, for example, a server, electronic control board, processor or the like. The devices are, for example, sensors, actuators and the like.

Also, anomalies in the control system 20 are anomalies that occur due to attacks and the like on the control system 20. Attacks are, for example, attacks and the like that place the control system 20 in an inappropriate state, due to malware or a malicious operator inserting unauthorized commands or the like or tampering with sequences in the control system 20. There are also attacks that are difficult to detect, even using techniques such as whitelisting, for example.

Next, as shown in FIG. 2, the anomaly detection apparatus 1 in the example embodiment has a detection unit 21 and an output information generation unit 22, in addition to the period specification unit 2 and the feature extraction unit 3. Also, an output device 23 is connected to the anomaly detection apparatus 1.

The learning phase of the anomaly detection apparatus will now be described.

The anomaly detection apparatus 1, in the learning phase, extracts sequence feature amounts using the period specification unit 2 and the feature extraction unit 3, and stores the extracted sequence feature amounts in a storage unit that is not shown. Note that the storage unit may be provided inside the anomaly detection apparatus 1 or may be provided outside the anomaly detection apparatus 1.

The period specification unit 2, in the learning phase, determines the periods of the packet types, using the packet intervals calculated for every packet type obtained by classifying the learning packets, and the frequencies indicating the incidence rates of the calculated packet intervals. Thereafter, the period specification unit 2 stores the determined periods of the packet types in the storage unit.

Specifically, the period specification unit 2, in the learning phase, receives packets (learning packets) in time series from the control system 20, in the case where the control system 20 is operated normally. Learning packets may, however, be stored in the storage unit in advance.

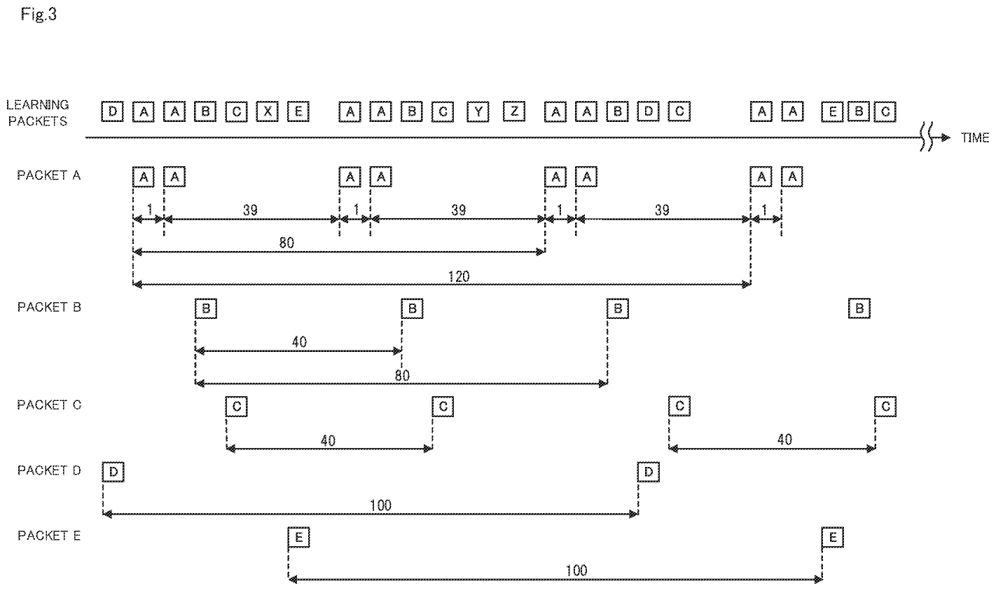

Next, the period specification unit 2 classifies the learning packets, based on the types (e.g., types such as read, write, etc.) of learning packets, for example. FIG. 3 is a diagram for describing classification of packets. For example, as shown in FIG. 3, the period specification unit 2 classifies the learning packets acquired in time series from the control system 20 that is being operated normally, during a predetermined time period. In the example in FIG. 3, the learning packets are classified into packet types A, B, C, D and E.

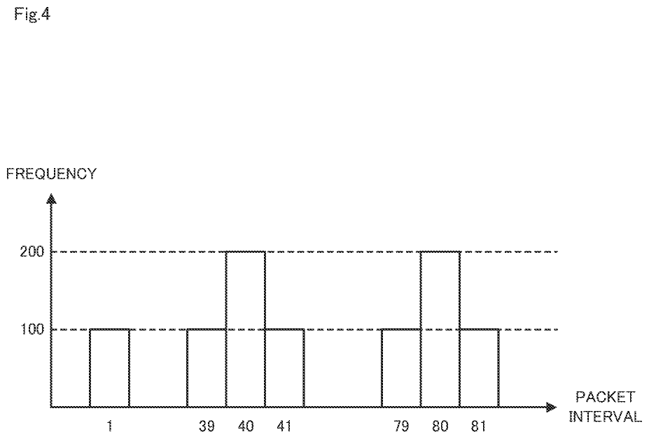

Next, the period specification unit 2 calculates packet intervals for every packet type. For example, as shown in FIG. 3, the period specification unit 2 calculates packet intervals for packets A to D. Thereafter, the period specification unit 2 calculates the incidences, or frequencies, at which the packet intervals occur, during a predetermined time period. FIG. 4 is a diagram for describing the relationship between the packet interval and frequency of packet A.

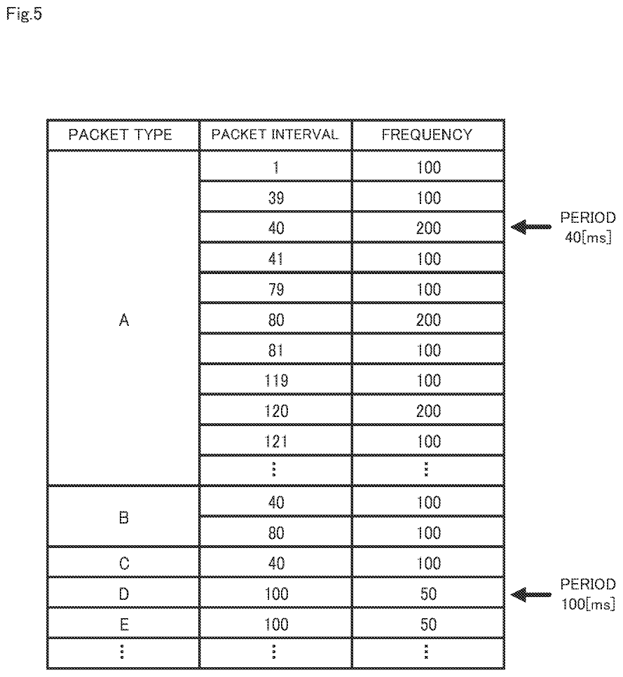

Next, the period specification unit 2 stores the packet types, packet intervals for every packet type, and frequencies corresponding to the packet intervals in association with each other in the storage unit. FIG. 5 is a diagram for describing an example of the data structure of information that associates classified packets, packet intervals and frequencies.

Next, the period specification unit 2 determines the periods of the packet types, using the packet intervals and the frequencies corresponding to the packet intervals. For example, the period specification unit 2 selects the smallest packet interval from among the packet intervals whose frequency is highest, and determines the period based on the selected packet interval. In the example in FIG. 5, the period specification unit 2 selects 40 [ms], which is the smallest packet interval, from among the packet intervals whose highest frequency corresponds to 200, and determines the period to be 40 [ms].

Next, the period specification unit 2 detects and excludes packets, other than packet A, having the packet interval 40 [ms]. That is, in the example in FIG. 5, packets B and C are excluded. This leaves packets D and E, and thus the smallest packet interval is similarly selected from among the packet intervals whose frequency is highest. As a result, in the example in FIG. 5, the period specification unit 2 selects 100 [ms], which is the smallest packet interval, from among the packet intervals whose highest frequency corresponds to 100, and determines the period to be 100 [ms].

Note that, in the example in FIG. 5, packets A, B and C are constituted by only the packet interval 40 [ms], and packets D and E do not include 40 [ms], but one packet type may include a plurality of periods. For example, if packet F has both the packet intervals 40 [ms] and 90 [ms], in the processing regarding the packet interval 40 [ms], only the packet interval 40 [ms] is excluded (=“used”) in packet F. The packet interval 90 [ms] remains as is.

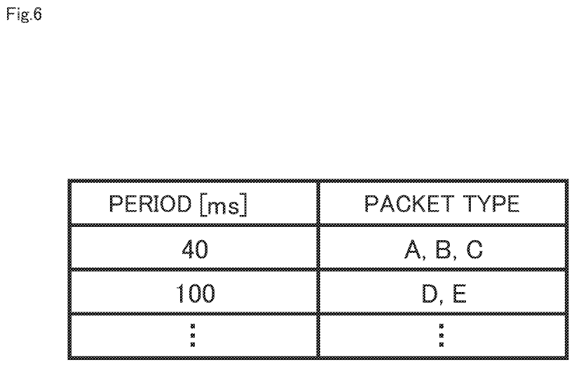

Next, the period specification unit 2 groups the classified packets, based on the determined periods. FIG. 6 is a diagram for describing grouping of packets. In the example in FIG. 6, the packets are grouped into packets A, B and C having the period 40 [ms] and packets D and E having the period 100 [ms], because the period specification unit 2 determined 40 [ms] and 100 [ms] as the periods in the example in FIG. 5.

Note that, in the case where the frequency is less than a predetermined value during normal operation, the period specification unit 2 does not need to determine the period using that frequency and the corresponding packet interval. The predetermined value is determined through testing, simulation and the like.

In the learning phase, the feature extraction unit 3 extracts, for every period, a sequence feature amount having sequence information indicating the order of classified packets and information indicating the time distribution between packets in the sequence. Specifically, the feature extraction unit 3 acquires the packets grouped by period, and generates sequence information, using a period identical to that period or a period that is a multiple thereof.

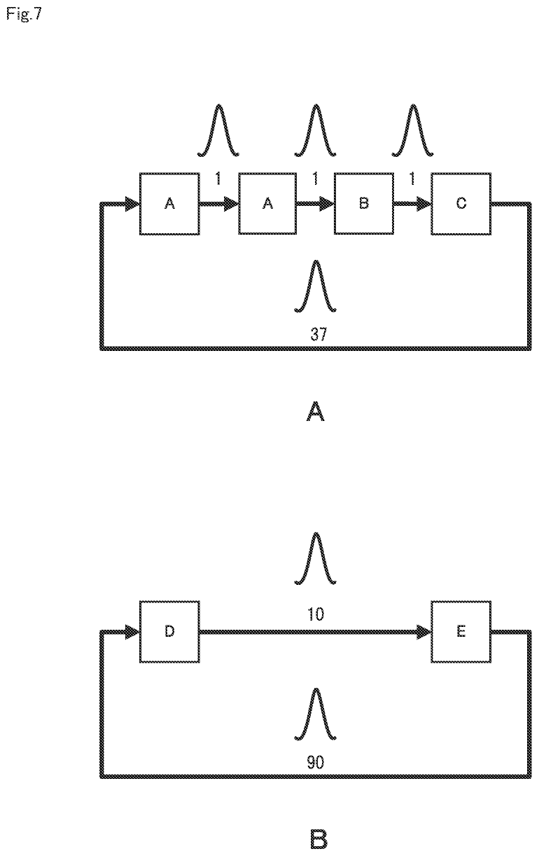

FIG. 7 is a diagram for describing the sequence information. In the example in FIG. 7, the feature extraction unit 3 uses packets A, B and C having the period 40 [ms], shown in the example in FIG. 6, to generate a sequence corresponding to packets A, B and C having the period 40 [ms], such as shown in A of FIG. 7, with reference to the learning packets stored in time series.

The sequence shown in A of FIG. 7 is a sequence showing that packet A is newly received 1 [ms] after receiving packet A, that packet B is received 1 [ms] after newly receiving packet A, that packet C is received 1 [ms] after receiving packet B, and that packet A corresponding to the initial packet A is received 37 [ms] after receiving packet C.

Also, in the example in FIG. 7, the feature extraction unit 3 uses packets D and E having the period 100 [ms], grouped in the example in FIG. 6, to generate a sequence corresponding to packets D and E having the period 100 [ms], such as shown in B of FIG. 7, with reference to the learning packets stored in time series.

The sequence shown in B of FIG. 7 is a sequence showing that packet E is received 10 [ms] after receiving packets D and E, and that packet D corresponding to the initial packet D is received 90 [ms] after receiving packet E.

Next, the feature extraction unit 3 calculates the time distribution between the packets in the abovementioned sequences. The time distribution between packets is a mean, variance or standard deviation, for example.

Next, the feature extraction unit 3 stores, in the storage unit, a sequence feature amount that associates identification information (sequence ID) identifying the sequence, sequence information indicating the order of the packets, and time distribution information indicating the time distribution between packets.

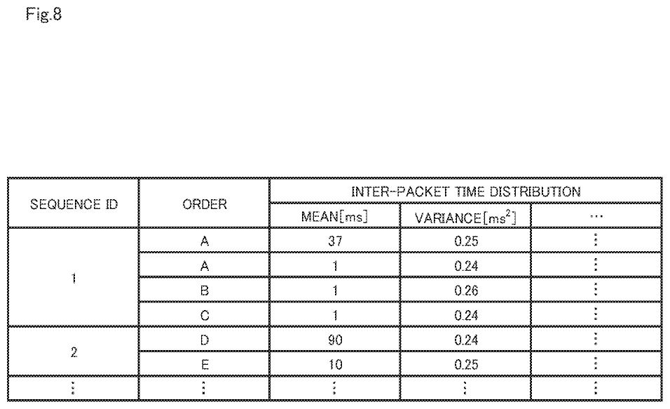

FIG. 8 is a diagram showing an example of the data structure of the sequence feature amounts. In the example in FIG. 8, the sequence feature amount gives “1” as the “sequence ID” to the sequence corresponding to the period 40 [ms], and gives “2” as the “sequence ID” to the sequence corresponding to the period 100 [ms].

Also, the order “A, A, B, C” corresponding to the period 40 [ms] is associated with the “sequence ID” “1”. The order “D, E” corresponding to the period 100 [ms] is associated with the “sequence ID” “2”.

Also, the packets “A”, “A”, “B” and “C” shown in the “sequence ID” “1” are respectively associated with “inter-packet time distribution” (“mean [ms]”, “variance [ms²]”, . . . ) respectively corresponding to the packets “A”, “A”, “B” and “C”. The packets “D” and “E” shown in the “sequence ID” “2” are respectively associated with “inter-packet time distribution” (“mean [ms]”, “variance [ms²]” . . . ) respectively corresponding to the packets “D” and “E”.

The operation phase of the anomaly detection apparatus will now be described.

The anomaly detection apparatus 1, in the operation phase, detects an anomaly in the control system 20, using the detection unit 21. Thereafter, the output information generation unit 22 of the anomaly detection apparatus 1 generates output information for outputting that an anomaly in the control system 20 was detected to the output device 23, and transmits the generated output information to the output device 23.

The detection unit 21, in the operation phase, receives packets from the control system 20. Next, the detection unit 21 detects an anomaly using the received packets, with reference to the sequence feature amounts extracted at the time of learning. Specifically, upon receiving packets for a predetermined time, the detection unit 21 determines whether there is an anomaly, with reference to the inter-packet time distribution and the sequence information of the sequence feature amounts.

The detection unit 21 compares the order of the packet types of the packets received in time series with the order of the packet types of the sequence feature amount, and determines that there is no anomaly in the sequence if the orders of the packet types are the same, and that there is an anomaly in the sequence if the orders of the packet types are different.

Furthermore, the detection unit 21 calculates the inter-packet time distribution, using the packets received in time series, and determines, with reference to the inter-packet time distribution extracted in the learning phase, that there is no anomaly if the inter-packet time distributions are similar, and that there is an anomaly if the inter-packet time distributions are not similar.

Note that because packets of the same type could possibly exist in a plurality of sequences, the detection unit 21 executes the determination of the order of the packet types in parallel with the determination of the inter-packet time distribution. This is because packet A is not limited to being included in only one sequence, and may be included in different sequences.

For example, it is also conceivable that “AXXY” having a period 65 [ms] corresponding to a sequence ID “3” will appear at the same time, in addition to “AABC” corresponding to the sequence ID “1” mentioned above. In such a case, “AXXY” may appear in an overlapping manner with “AABC”.

When “AABC” is considered, focusing on the order of the three types of packets A, B and C gives “AAABC”, but in order avoid this being judged to be a sequence anomaly, it must be determined that one of the three As of “AAABC” is actually the “A” of the sequence “AXXY”.

In view of this, determination that the next packet will actually arrive in a range of the time distribution expected for the sequence (determination of an inter-packet time distribution anomaly) is performed, in addition to the determination of a sequence anomaly in which a packet belonging to one of the sequences arrives at a timing not expected for any of the sequences.

In this way, from the viewpoint of the sequence, determination as to whether packets are arriving at the expected timing (determination for detecting the case where packets are not arriving at the expected timing) is performed, and, from the viewpoint of the received packet, determination as to whether the packet is the expected packet (determination for detecting superfluous packets) is performed.

Next, if the detection unit 21 detects an anomaly, the detection unit 21 transmits an instruction indicating that an anomaly was detected to the output information generation unit 22.

If an anomaly instruction is acquired, the output information generation unit 22 generates output information for outputting that an anomaly has occurred in the control system 20 to the output device 23, in order to notify a user such as an administrator of the control system 20.

The output device 23 acquires, from the output information generation unit 22, output information converted into a form that can be output, and outputs an image, audio or the like generated based on the acquired output information. The output device 23 is an image display unit that uses liquid crystal, organic EL (electroluminescence) or CRT (cathode ray tubes), for example. Furthermore, the output device 23 may have an audio output device such as a speaker. Note that the output device 23 may also be a printing device such as a printer.

[Apparatus Operations]

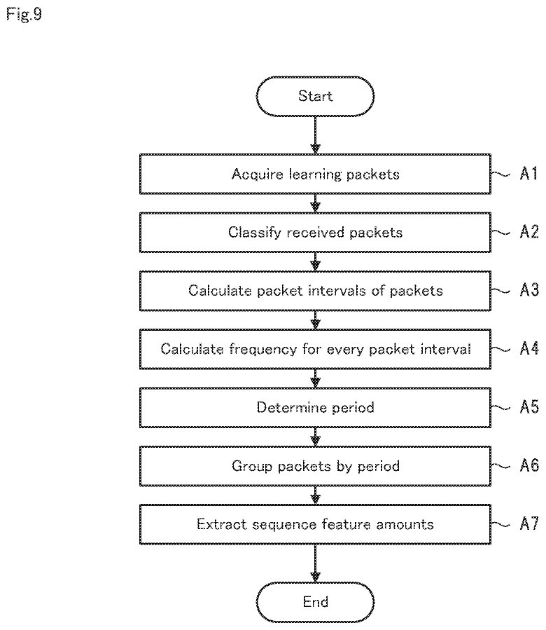

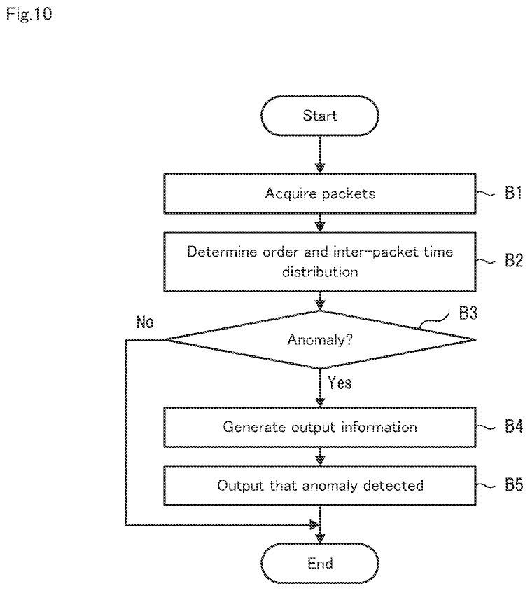

Next, operations of the anomaly detection apparatus 1 in the example embodiment of the invention will be described. Operations of the learning phase will be described using FIG. 9. Also, operations in the operation phase will be described using FIG. 10. FIG. 9 is a diagram for describing an example of operations of the anomaly detection apparatus in the learning phase. FIG. 10 is a flow diagram for describing an example of operations of the anomaly detection apparatus in the operation phase. In the following description, FIGS. 2 to 8 will be referred to as appropriate. Also, in the example embodiment, the anomaly detection method is implemented by operating the anomaly detection apparatus 1. Therefore, the following description of the operations of the anomaly detection apparatus 1 will be given in place of a description of the anomaly detection method according to the example embodiment.

Operations of the anomaly detection apparatus in the learning phase will now be described.

As shown in FIG. 9, initially, the period specification unit 2 acquires learning packets (step A1). Specifically, in step A1, the period specification unit 2 receives learning packets from the control system 20 in time series in the learning phase, in the case where the control system 20 is operated normally. Alternatively, the period specification unit 2 may acquire learning packets that were stored in the storage unit in advance.

Next, the period specification unit 2 classifies the learning packets (step A2). Specifically, in step A2, the period specification unit 2 classifies the learning packets according to type (e.g., types such as read, write, etc.). For example, as shown in FIG. 3, the period specification unit 2 classifies the learning packets acquired in time series from the control system 20 that is being operated normally, during a predetermined time period.

Next, the period specification unit 2 calculates packet intervals for every packet type of the classified learning packets (step A3). Specifically, in step A3, as shown in FIG. 3, the period specification unit 2 calculates packet intervals for packets A to D. Next, the period specification unit 2 calculates the incidences, or frequencies, at which the packet intervals occur, during a predetermined time period (step A4).

Note that, in step A4, the period specification unit 2 stores the packet types, packet intervals for every packet type, and frequencies corresponding to the packet intervals in association with each other in the storage unit.

Next, the period specification unit 2 determines the period, using the packet intervals for every packet type and the frequencies corresponding to those packet intervals (step A5). Specifically, in step A5, the period specification unit 2 selects the smallest packet interval from among the packet intervals whose frequency is highest, and determines the period based on the selected packet interval. In the example in FIG. 5, the period specification unit 2 selects 40 [ms], which is the smallest packet interval, from the packet intervals whose highest frequency corresponds to 200, and determines the period to be 40 [ms].

Also, the period specification unit 2 detects and excludes packets, other than packet A, having the packet interval 40 [ms]. That is, in the example in FIG. 5, packets B and C are excluded. This leaves packets D and E, and thus the smallest packet interval is similarly selected from among the packet intervals whose frequency is highest. As a result, in the example in FIG. 5, the period specification unit 2 selects 100 [ms], which is the smallest packet interval, from among the packet intervals whose highest frequency corresponds to 100, and determines the period to be 100 [ms].

Note that, in the example in FIG. 5, packets A, B and C are constituted by only the packet interval 40 [ms], and packets D and E do not include 40 [ms], but one packet type may include a plurality of periods. For example, if packet F has both the packet intervals 40 [ms] and 90 [ms], in the processing regarding the packet interval 40 [ms], only the packet interval 40 [ms] is excluded (=“used”) in packet F. The packet interval 90 [ms] remains as is.

Next, the period specification unit 2 groups the packet types, based on the determined periods (step A6). Specifically, in step A6, the packets are grouped into packets A, B and C having the period 40 [ms] and packets D and E having the period 100 [ms], because the period specification unit 2 determined 40 [ms] and 100 [ms] as the periods in the example in FIG. 5.

Note that, in the case where the frequency is less than a predetermined value during normal operation, the period specification unit 2 does not need to determine the period using that frequency and the corresponding packet interval. The predetermined value is determined through testing, simulation and the like.

Next, the feature extraction unit 3 extracts, for every period, a sequence feature amount having sequence information indicating the order of packet types and information indicating the time distribution between packets in the sequence (step A7). Specifically, in step A7, the feature extraction unit 3 acquires the packet types grouped by period, and generates sequence information, using a period identical to that period or a period that is a multiple thereof.

In the example in FIG. 7, the feature extraction unit 3 uses packets A, B and C having the period 40 [ms], shown in the example in FIG. 6, to generate a sequence corresponding to packets A, B and C having the period 40 [ms], such as shown in A of FIG. 7, with reference to the learning packets stored in time series.

Also, in the example in FIG. 7, the feature extraction unit 3 uses packets D and E having the period 100 [ms], grouped in the example in FIG. 6, to generate a sequence corresponding to packets D and E having the period 100 [ms], such as shown in B of FIG. 7, with reference to the learning packets stored in time series.

Also, in step A7, the feature extraction unit 3 calculates the time distribution between the packets in the abovementioned sequences. The time distribution between packets is a mean, variance or standard deviation, for example.

Note that, in step A7, the feature extraction unit 3 stores a sequence feature amount that associates identification information (sequence ID) identifying the sequence, sequence information indicating the order of the packets, and time distribution information indicating the time distribution between packets.

Operations of the anomaly detection apparatus in the operation phase will now be described.

The detection unit 21, first, acquires packets from the control system 20 (step B1). Next, the detection unit 21 performs determination of a sequence anomaly (order of packet types), and determination of the inter-packet time distribution (step B2) and ends this processing if there is no anomaly (step B3: No). If there is an anomaly (step B3: Yes), the processing transitions to step B4.

Specifically, in step B2, the detection unit 21 compares the order of the packet types received in time series with the order of the packet types of the sequence feature amount, and determines that there is no anomaly in the sequence if the orders of the packet types are the same. The detection unit 21 determines that there is an anomaly if the orders are different.

Furthermore, in step B2, the detection unit 21 calculates the inter-packet time distribution, using the packets received in time series, and determines, with reference to the inter-packet time distribution extracted in the learning phase, that there is no anomaly if the inter-packet time distributions are similar, and that there is an anomaly if the inter-packet time distributions are not similar.

Next, the output information generation unit 22 generates output information (step B4). Specifically, in step B4, the output information generation unit 22 generates output information indicating that an anomaly has occurred in the control system 20 to the output device 23, in order to notify a user such as an administrator of the control system 20, in the case where a sequence anomaly or an inter-packet time distribution anomaly is acquired (step B4). Next, the output device 23 acquires, from the output information generation unit 22, output information converted into a form that can be output, and outputs an image, audio or the like generated based on the acquired output information (step B5), before ending the processing.

### Effects of Example Embodiment

According to the example embodiment as described above, the accuracy for detecting anomalies that occur in the control system can be improved in the operation phase, by using sequence feature amounts extracted in the learning phase.

Specifically, in the operation phase, anomalies are detected using packets received from the control system, with reference to sequence feature amounts extracted at the time of learning. This enables the accuracy for detecting anomalies that occur in the control system to be improved.

Also, anomalies can be accurately detected, even with a system that is constituted by a plurality of different sequences.

[Programs]

Programs according to the example embodiment need only be programs that cause a computer to execute steps A1 to A7 shown in FIG. 9 and steps B1 to B5 shown in FIG. 10. The anomaly detection apparatus and the anomaly detection method according to the example embodiment can be realized, by such programs being installed on a computer and executed. In this case, a processor of the computer performs processing while functioning as the period specification unit 2, the feature extraction unit 3, the detection unit 21, and the output information generation unit 22.

Also, programs according to the example embodiment may be executed by a computer system constructed from a plurality of computers. In this case, for example, the computers may each function as one of the period specification unit 2, the feature extraction unit 3, the detection unit 21 and the output information generation unit 22.

[Physical Configuration]

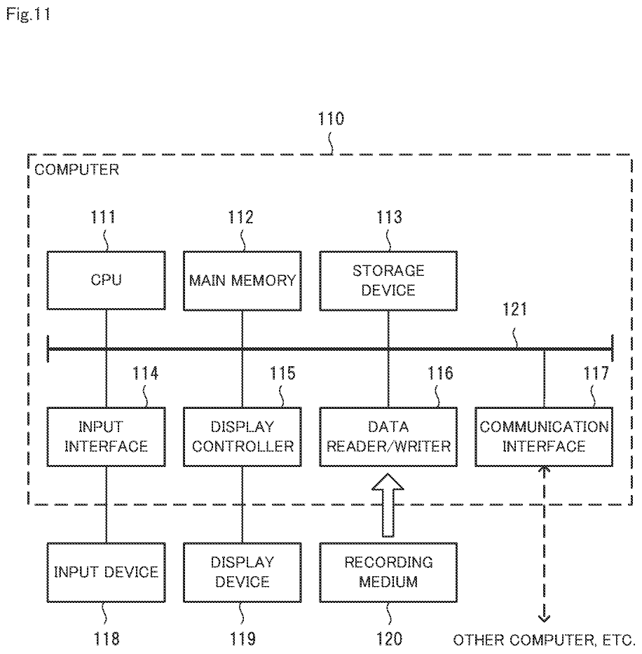

Here, a computer that realizes the anomaly detection apparatus by executing programs according to the example embodiment will be described using FIG. 11. FIG. 11 is a block diagram showing an example of a computer that realizes the anomaly detection apparatus.

As shown in FIG. 11, a computer 110 is provided with a CPU 111, a main memory 112, a storage device 113, an input interface 114, a display controller 115, a data reader/writer 116, and a communication interface 117. These units are connected to each other in a data communicable manner, via a bus 121. Note that the computer 110 may be provided with e a GPU (Graphics Processing Unit) or an FPGA (Field-Programmable Gate Array), in addition to the CPU 111 or instead of the CPU 111.

The CPU 111 implements various computational operations, by extracting programs (code) according to the example embodiment stored in the storage device 113 to the main memory 112, and executing these programs in predetermined order. The main memory 112, typically, is a volatile storage device such as a DRAM (Dynamic Random Access Memory). Also, programs according to the example embodiment are provided in a state of being stored on a computer-readable recording medium 120. Note that programs according to the example embodiment may be distributed over the Internet connected via the communication interface 117.

Also, a semiconductor storage device such as a flash memory is given as a specific example of the storage device 113, other than a hard disk drive. The input interface 114 mediates data transmission between the CPU 111 and input devices 118 such as a keyboard and a mouse. The display controller 115 is connected to a display device 119 and controls display by the display device 119.

The data reader/writer 116 mediates data transmission between the CPU 111 and the recording medium 120, and executes readout of programs from the recording medium 120 and writing of processing results of the computer 110 to the recording medium 120. The communication interface 117 mediates data transmission between the CPU 111 and other computers.

Also, a general-purpose semiconductor storage device such as a CF (Compact Flash (registered trademark)) card or an SD (Secure Digital) card, a magnetic storage medium such as a flexible disk, and an optical storage medium such as a CD-ROM (Compact Disk Read Only Memory) are given as specific examples of the recording medium 120.

Note that the anomaly detection apparatus 1 according to the example embodiment is also realizable by using hardware corresponding to the respective units, rather than by a computer on which programs are installed. Furthermore, the anomaly detection apparatus 1 may be realized in part by programs, and the remaining portion may be realized by hardware.

The following supplementary notes are further disclosed in relation to the above example embodiments. The example embodiments described above can be partially or wholly realized by supplementary notes 1 to 12 described below, but the invention is not limited to the following description.

(Supplementary Note 1)

An anomaly detection apparatus including:

a period specification unit configured to, at a time of learning, classify learning packets by type, and, with use of a packet interval calculated for every packet type and a frequency indicating an incidence rate of the packet interval, specify a period of the packet type; and

a feature extraction unit configured to extract, based on the period, a sequence feature amount having sequence information indicating an order of the packet types and information indicating a time distribution between packets in the sequence information.

(Supplementary Note 2)

The anomaly detection apparatus according to supplementary note 1, including:

a detection unit configured to detect an anomaly at a time of operation, using packets received from the control system, with reference to the sequence feature amount extracted at the time of learning.

(Supplementary Note 3)

The anomaly detection apparatus according to supplementary note 1 or 2,

whereby the period specification unit selects a smallest packet interval from among packet intervals whose frequency is highest, and determines the period based on the selected packet interval.

(Supplementary Note 4)

The anomaly detection apparatus according to any one of supplementary notes 1 to 3,

whereby the feature extraction unit extracts the sequence feature amount, using a period identical to the period or a period that is a multiple of the period.

(Supplementary Note 5)

An anomaly detection method including:

(a) a step of, at a time of learning, classifying learning packets by type, and, with use of a packet interval calculated for every packet type and a frequency indicating an incidence rate of the packet interval, specifying a period of the packet type; and

(b) a step of extracting, based on the period, a sequence feature amount having sequence information indicating an order of the packet types and information indicating a time distribution between packets in the sequence information.

(Supplementary Note 6)

The anomaly detection method according to supplementary note 5, including:

(c) a step of detecting an anomaly at a time of operation, using packets received from the control system, with reference to the sequence feature amount extracted at the time of learning.

(Supplementary Note 7)

The anomaly detection method according to supplementary note 5 or 6,

whereby, in the (a) step, a smallest packet interval is selected from among packet intervals whose frequency is highest, and the period is determined based on the selected packet interval.

(Supplementary Note 8)

The anomaly detection method according to any one of supplementary notes 5 to 7,

whereby, in the (b) step, the sequence feature amount is extracted, using a period identical to the period or a period that is a multiple of the period.

(Supplementary Note 9)

A computer-readable recording medium that includes a program recorded thereon, the program including instructions that cause a computer to carry out:

(a) a step of, at a time of learning, classifying learning packets by type, and, with use of a packet interval calculated for every packet type and a frequency indicating an incidence rate of the packet interval, specifying a period of the packet type; and

(b) a step of extracting, based on the period, a sequence feature amount having sequence information indicating an order of the packet types and information indicating a time distribution between packets in the sequence information.

(Supplementary Note 10)

The computer-readable recording medium according to supplementary note 9, the program including instructions that cause the computer to carry out:

(c) a step of detecting an anomaly at a time of operation, using packets received from the control system, with reference to the sequence feature amount extracted at the time of learning.

(Supplementary Note 11)

The computer-readable recording medium according to supplementary note 9 or 10,

whereby, in the (a) step, a smallest packet interval is selected from among packet intervals whose frequency is highest, and the period is determined based on the selected packet interval.

(Supplementary Note 12)

The computer-readable recording medium according to any one of supplementary notes 9 to 11,

whereby, in the (b) step, the sequence feature amount is extracted, using a period identical to the period or a period that is a multiple of the period.

Although the invention has been described above with reference to example embodiments, the invention is not limited to the foregoing example embodiments. Various modifications apparent to those skilled in the art can be made to the configurations and specifics of the invention within the scope of the invention.

### INDUSTRIAL APPLICABILITY

According to the invention as described above, the accuracy for detecting anomalies that occur in a control system can be improved in an operation phase, by detecting anomalies using packets received from the control system, with reference to sequence feature amounts extracted at the time of learning. The invention is useful in fields for detecting anomalies that occur in a control system.

### LIST OF REFERENCE SIGNS

1 Anomaly detection apparatus
2 Period specification unit
3 Feature extraction unit
20 Control system
21 Detection unit
22 Output information generation unit
23 Output device
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An anomaly detection apparatus comprising:
a period specification unit that, at a time of learning, classifying learning packets by type, and, with use of a packet interval calculated for every packet type and a frequency indicating an incidence rate of the packet interval, specifying a period of the packet type; and
a feature extraction unit that extracts, based on the period, a sequence feature amount having sequence information indicating an order of the packet types and information indicating a time distribution between packets in the sequence information.

2. The anomaly detection apparatus according to claim 1, comprising: a detection unit that detects an anomaly at a time of operation, using packets received from the control system, with reference to the sequence feature amount extracted at the time of learning.

3. The anomaly detection apparatus according to claim 1,
wherein the period specification unit selects a smallest packet interval from among packet intervals whose frequency is highest, and determines the period based on the selected packet interval.

4. The anomaly detection apparatus according to claim 1,
wherein the feature extraction unit extracts the sequence feature amount, using a period identical to the period or a period that is a multiple of the period.

5. An anomaly detection method comprising:
at a time of learning, classifying learning packets by type, and, with use of a packet interval calculated for every packet type and a frequency indicating an incidence rate of the packet interval, specifying a period of the packet type; and
extracting, based on the period, a sequence feature amount having sequence information indicating an order of the packet types and information indicating a time distribution between packets in the sequence information.

6. The anomaly detection method according to claim 5, comprising:
detecting an anomaly at a time of operation, using packets received from the control system, with reference to the sequence feature amount extracted at the time of learning.

7. The anomaly detection method according to claim 5,
wherein, a smallest packet interval is selected from among packet intervals whose frequency is highest, and the period is determined based on the selected packet interval.

8. The anomaly detection method according to claim 5,
wherein, the sequence feature amount is extracted, using a period identical to the period or a period that is a multiple of the period.

9. A non-transitory computer-readable recording medium that includes a program recorded thereon, the program including instructions that cause a computer to carry out:
at a time of learning, classifying learning packets by type, and, with use of a packet interval calculated for every packet type and a frequency indicating an incidence rate of the packet interval, specifying a period of the packet type; and
extracting, based on the period, a sequence feature amount having sequence information indicating an order of the packet types and information indicating a time distribution between packets in the sequence information.

10. The non-transitory computer-readable recording medium according to claim 9, the program including instructions that cause the computer to carry out:
detecting an anomaly at a time of operation, using packets received from the control system, with reference to the sequence feature amount extracted at the time of learning.

11. The non-transitory computer-readable recording medium according to claim 9,
wherein, a smallest packet interval is selected from among packet intervals whose frequency is highest, and the period is determined based on the selected packet interval.

12. The non-transitory computer-readable recording medium according to claim 9,
wherein, the sequence feature amount is extracted, using a period identical to the period or a period that is a multiple of the period.
